(19) United States
(12) Patent Application Publication
(10) Pub. No.: US 2016/0034926 A1
(43) Pub. Date: Feb. 4, 2016

(54) DETERMINING A MONETARY VALUE FOR AN OUTCOME BASED ON A USER'S ACTIVITY

(71) Applicant: International Business Machines Corporation, Armonk, NY (US)

(72) Inventors: Jorge A. Arroyo, Carmel, IN (US); Stephen P. Kruger, Dublin (IE); Patrick J. O'Sullivan, Dublin (IE); Luciano Silva, Apex, NC (US)

(73) Assignee: International Business Machines Corporation, Armonk, NY (US)

(21) Appl. No.: 14/709,100

(22) Filed: May 11, 2015

Related U.S. Application Data
(63) Continuation of application No. 14/450,117, filed on Aug. 1, 2014.

(51) Int. Cl. G06Q 30/02

(52) U.S. Cl. CPC G06Q 30/0202

(57) ABSTRACT

Determining a monetary value for an outcome based on a user's activity includes monitoring activities of a user utilizing a number of applications associated with a customer relationship management (CRM) system, determining, based on monitoring the activities of the user utilizing the number of applications, outcomes for the activities of the user, the outcomes being associated with opportunities stored in the CRM system, assigning a contribution value to the outcome based on the activities of the user, and determining, based on the contribution value, a monetary value for the outcomes.

### BACKGROUND

The present invention relates to determining a monetary value for an outcome, and more specifically, to determining a monetary value for an outcome based on a user's activity.

A customer relationship management (CRM) system uses techniques and methods to gather, organize, automate, and synchronize sales, for marketing, customer service, and technical support. This information is stored in the CRM system's memory. Further, this information is retrieved from the CRM system's memory and analyzed to allow a company to better target various customers.

### BRIEF SUMMARY

A method for determining a monetary value for an outcome based on a user's activity includes monitoring activities of a user utilizing a number of applications associated with a customer relationship management (CRM) system, determining, based on monitoring the activities of the user utilizing the number of applications, outcomes for the activities of the user, the outcomes being associated with opportunities stored in the CRM system, assigning a contribution value to the outcomes based on the activities of the user, and determining, based on the contribution value, a monetary value for the outcomes.

A system for determining a monetary value for an outcome based on a user's activity includes a monitoring engine to monitor activities of a user utilizing a number of applications associated with a CRM system, an opportunity determining engine to determine opportunities associated with the number of applications, an identifying engine to identify content related to the opportunities, an outcome determining engine to determine, based on monitoring the activities of the user utilizing the number of applications, outcomes for the activities of the user, the outcomes being associated with the opportunities stored in the CRM system, an assigning engine to assign a contribution value to the outcomes based on the activities of the user, and a monetary value determining engine to determine, based on the contribution value, a monetary value for the outcomes.

A computer program product includes a computer readable storage medium, the computer readable storage medium having computer readable program code embodied therewith. The computer readable program code having computer readable program code to determine, based on monitoring activities of a user utilizing a number of applications, outcomes for the activities of the user, the outcomes being associated with opportunities stored in a CRM system, assign a contribution value to the outcomes based on the activities of the user, and determine, based on the contribution value, a monetary value for the outcomes.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for determining a monetary value for an outcome based on a user's activity, according to one example of principles described herein.

FIG. 2 is a diagram of an example of a system for determining a monetary value for an outcome based on a user's activity, according to one example of principles described herein.

FIG. 3 is a flowchart of an example of a method for determining a monetary value for an outcome based on a user's activity, according to one example of principles described herein.

FIG. 4 is a flowchart of an example of a method for determining a monetary value for an outcome based on a user's activity, according to one example of principles described herein.

FIG. 5 is a diagram of an example of a determining system, according to the principles described herein.

FIG. 6 is a diagram of an example of a determining system, according to the principles described herein.

Throughout the drawings, identical reference numbers designate similar, but not necessarily identical, elements.

### DETAILED DESCRIPTION

The present specification describes a method and system for determining a monetary value for an outcome based on a user's activity, such that the monetary value assigned to an outcome of an opportunity accurately reflects the user's contribution to the outcome.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the customer relationship management (CRM) system uses techniques and methods to organize, automate, and synchronize sales, for marketing, customer service, and technical support. This information that the CRM system gathers is stored in the CRM system's memory. Further, this information may be categorized as opportunities in the CRM system's memory. A user associated with a company may view the opportunities gather by the CRM system to allow the company to better target various customers.

Often, an outcome of an opportunity may be influenced by a number of users, for example employees of a company. In one example, each of the users may contribute more or less of their time to influence the outcome of the opportunity. For example, user A and user B may contribute their time to ensure opportunity A has a successful outcome. In this example, user A contributes three hours of their time to make opportunity A's outcome successful. User B contributes five hours of their time to make opportunity A's outcome successful.

In one example, this information is then used to establish a monetary value for billing purposes for the company. For example, the company manually determines user A contributed three hours of their time to make opportunity A's outcome successful and user B contributed five hours of their time to make opportunity A's outcome successful. Further, the company manually determines that user A has a compensation rate of twenty dollars per hour and user B has a compensation rate thirty dollars per hour. As a result, the monetary value for opportunity A's outcome may be manually calculated by multiplying the compensation rate for each user by how many hours each of the user's contributed to opportunity A's outcome. This results in a monetary value of two-hundred and ten dollars for opportunity A's outcome.

Manually determining this information for billing purposes can be a burdensome task for a company with thousands of employees. As a result, this may lead to additional costs for the company.

The principles described herein include a system and a method for determining a monetary value for an outcome based on a user's activity. Such a system and method includes monitoring activities of a user utilizing a number of applications associated with a CRM system, determining, based on monitoring the activities of the user utilizing the number of applications, outcomes for the activities of the user, the outcomes being associated with opportunities stored in the CRM system, assigning a contribution value to the outcomes based on the activities of the user, and determining, based on the contribution value, a monetary value for the outcomes. Such a method and system allows the monetary value assigned to the outcome to accurately reflects the user's contribution to the outcome in terms of currency. As a result, the monetary value may be further used for billing purposes by a company.

In the specification and appended claims, the term “application” is meant to be understood broadly as a mechanism for a user to contribute to an outcome of an opportunity. In one example, applications may include electronic mail (email), instant message applications, web conference applications, phone call applications, meeting applications, social media applications, or combinations thereof.

In the specification and appended claims, the term “outcome” is meant to be understood broadly as a final result of an opportunity. In one example, an outcome may be successful or unsuccessful. For example, an outcome for an opportunity that is successful may exhibit a profit gain for the opportunity. Further, an outcome for an opportunity that is unsuccessful may exhibit a profit loss for the opportunity.

In the specification and appended claims, the term “contribution value” is meant to be understood broadly as an amount of time a user contributes to an outcome of an opportunity. For example, if a user contributes three hours of their time to an outcome of an opportunity, a contribution value of three may be assigned to the outcome of the opportunity. In one example, the amount of time may be measured in minutes, hours, days, weeks, months, years, other measurements of time, or combinations thereof.

In the specification and appended claims, the term “monetary value” is meant to be understood broadly as a cost, in terms of currency, for an outcome of an opportunity to be realized. In one example, the monetary value may be calculated by multiplying a compensation value by a compensation rate of a user who contributed to an outcome of an opportunity. In another example, the monetary value may be calculated by multiplying a compensation value by a compensation rate of an organization who contributed to an outcome of an opportunity. For example, if an organization contributed three hours of their time to an outcome of an opportunity and the hourly rate of the organization is twenty dollars per hour, the monetary value is sixty dollars.

In the specification and appended claims, the term “opportunities” is meant to be understood broadly as a complex record structure in a CRM system, in which each of the opportunities captures a number of fields of metadata. In one example, the opportunities may include a business's sales and/or interaction with current customers, future customers, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

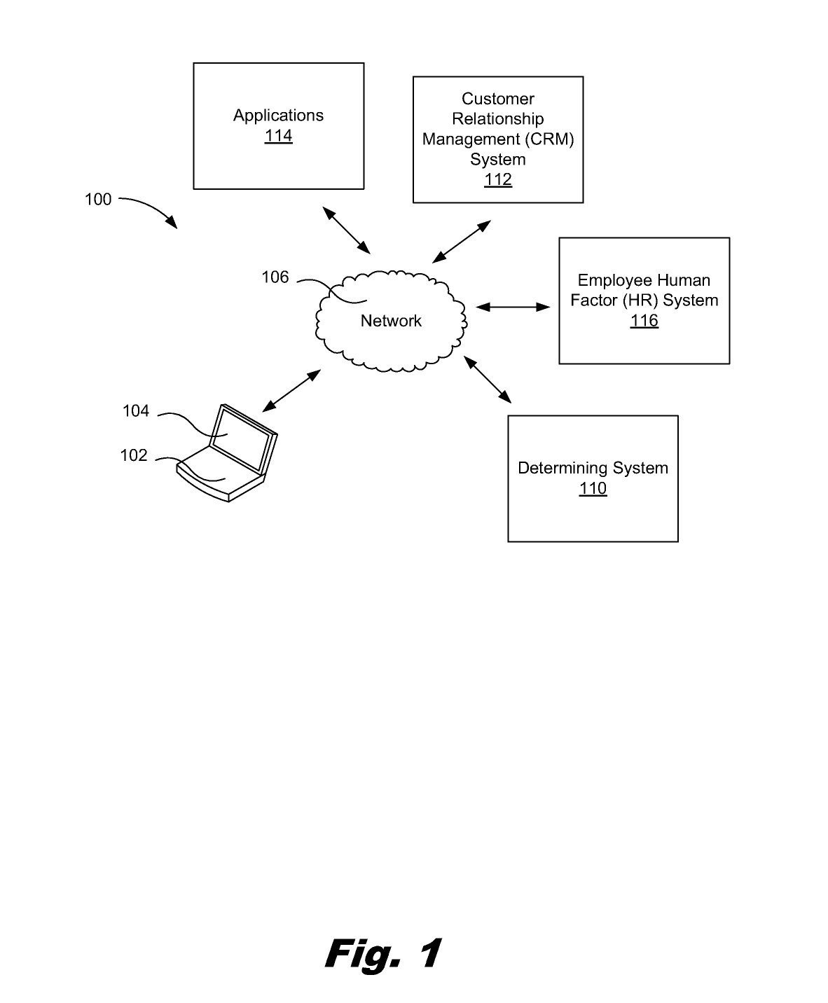

FIG. 1 is a diagram of an example of a system for determining a monetary value for an outcome based on a user's activity, according to one example of principles described herein. As will be described below, a determining system is in communication with a network to monitor activities of a user utilizing a number of applications associated with a CRM system. The determining system determines, based on monitoring the activities of the user utilizing the number of applications, outcomes for the activities of the user, the outcomes being associated with opportunities stored in the CRM system. Further, the determining system assigns a contribution value to the outcomes based on the activities of the user. The determining system determines, based on the contribution value, a monetary value for the outcomes.

As illustrated in FIG. 1, the system (100) includes a CRM system (112). As mentioned above, the CRM system (112) uses techniques and methods to gather, organize, automate, and synchronize sales, for marketing, customer service, and technical support. This information is stored in the CRM system's memory. Further, this information is retrieved from the CRM system's memory and analyzed to allow a company to better target various customers.

As illustrated in FIG. 1, the system (100) includes a determining system (110). The determining system (110) monitors activities of a user utilizing a number of applications (114) associated with a CRM system (112). In one example, the number of applications (114) includes email applications, instant message applications, web conference applications, phone call applications, meeting applications, social media applications, or combinations thereof. Further, the user may access the number of applications (114) via a user device (102) with a display (104) to contribute to outcomes of opportunities of the CRM system (112).

The determining system (110) determines, based on monitoring the activities of the user utilizing the number of applications (114), outcomes for the activities of the user, the outcomes being associated with opportunities stored in the CRM system (112). As mentioned above, the outcomes associated with opportunities stored in the CRM system (112) may be successful or unsuccessful.

Further, the determining system (110) assigns a contribution value to the outcomes based on the activities of the user. In one example, the contribution value is further based on a position of the user, a responsibility of the user, a customer contact of the user, an activity type for the activities, a contract, a commission for the user, or combinations thereof.

The determining system (110) determines, based on the contribution value, a monetary value for the outcomes. In one example, the determining system (110) interfaces with an employee human factor (HR) system (116), to derive information associated with the user to further determine the monetary value. As a result, the system (100) allows the monetary value assigned to the outcome to accurately reflects the user's contribution to the outcome in terms of currency. Further, the monetary value may be further used for billing purposes by a company. More information about the determining system (110) will be described in detail later on in this specification.

While this example has been described with reference to the determining system being located over the network, the determining system may be located in any appropriate location. For example, the determining system may be located in a user device, a database, a CRM system, other locations, or combinations thereof.

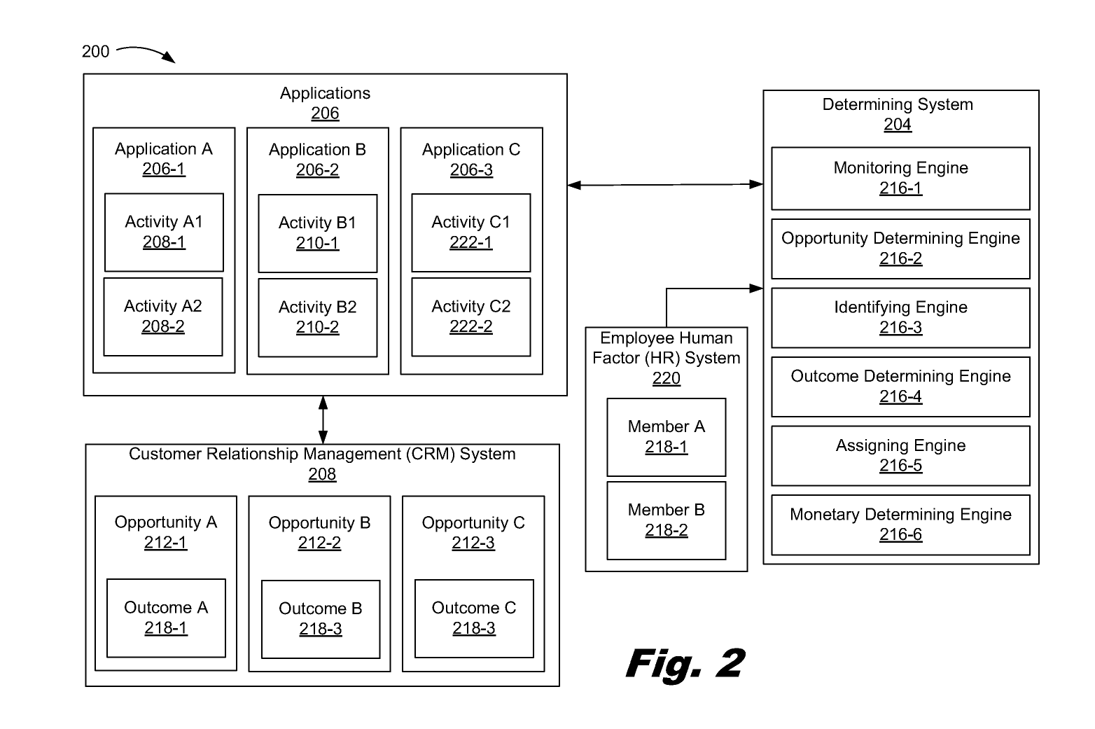

FIG. 2 is a diagram of an example of a system for determining a monetary value for an outcome based on a user's activity, according to one example of principles described herein. As mentioned above, a determining system is in communication with a network to monitor activities of a user utilizing a number of applications associated with a CRM system. The determining system determines, based on monitoring the activities of the user utilizing the number of applications, outcomes for the activities of the user, the outcomes being associated with opportunities stored in the CRM system. Further, the determining system assigns a contribution value to the outcomes based on the activities of the user. The determining system determines, based on the contribution value, a monetary value for the outcomes.

As illustrated in FIG. 2, the system (200) includes a CRM system (208). As mentioned above, the CRM system (208) is used as a model for managing a business's interactions with current and future customers. The CRM system (208) uses techniques and methods to organize, automate, and synchronize sales, for marketing, customer service, and technical support. In one example, the CRM system (208) may be a classical CRM system that monitors sources such as current customers and potentially future customers to gather information to better target various customers. The classical CRM system traditionally includes a one-way communication between a business and the customer.

In another example, the CRM system (208) may be a social CRM system that monitors sources such as social media sources. In this example, the social CRM system's strategy is based around customer engagement and interactions, with transactions being a byproduct. In one example, the Social CRM system may use a philosophy and a business strategy, supported by a technology platform, business rules, workflow, processes and social characteristics, designed to engage the customer in a collaborative conversation in order to provide mutually beneficial value in a trusted and transparent business environment. Further, the social CRM system includes applications in marketing, customer service and sales, including peer-to-peer customer support, idea management, market research, product launch, brand reputation management.

In this example, the social CRM system is a back-end process and system for managing customer relationships and data in an efficient and process-centric way. The social CRM system is able to understand the business's challenges that are to be solved and then solve the business's challenges. Further, the social CRM system may be one component of developing a social or collaborative business, both internally and externally.

Regardless of if the CRM system (208) is a classical CRM system or a social CRM system, they are used to gather information about opportunities and populate the CRM system (208) with the information gathered about the opportunities. As illustrated, the CRM system (208) includes a number of opportunities (212). For example, opportunity A (212-1), opportunity B (212-2), and opportunity C (212-3). As mentioned above, the opportunities (212) may be a complex record structure in the CRM system (208), in which each of the opportunities captures a number of fields of metadata. In one example, the opportunities may include a business's sales and/or interaction with current customers, future customers, or combinations thereof. Further, each of the opportunities (212) may be associated with an outcome (218). For example, opportunity A (212-1) is associated with outcome A (218-1), opportunity B (212-2) is associated with outcome B (218-2), and opportunity C (212-3) is associated with outcome C (218-3).

As illustrated in FIG. 2, the system includes a determining system (204). In one example, the determining system (204) includes a number of engines (216). The engines (216) refer to a combination of hardware and program instructions to perform a designated function. Each of the engines (216) may include a processor and memory. The program instructions are stored in the memory and cause the processor to execute the designated function of the engine. In this example, the determining system (204) includes a monitoring engine (216-1), an opportunity determining engine (216-2), an identifying engine (216-3), an outcome determining engine (216-4), an assigning engine (216-5), and a monetary value determining engine (216-6).

As mentioned above, the determining system (204) includes the monitoring engine (216-1). In one example, the monitoring engine (216-1) monitors activities of a user utilizing a number of applications (206) associated with the CRM system (208). In one example, the number of applications (206) may be email applications, instant message applications, web conference applications, phone call applications, meeting applications, social media applications, or combinations thereof. As illustrated, the applications (206) may include application A (206-1), application B (206-2), and application C (206-3). Further, the applications (206) may record the activities of the user. For example, application A (206-1) may include activity A1 (208-1) and activity A2 (208-2). Application B (206-2) may include activity B1 (210-1) and activity B2 (210-2). Application C (206-3) may include activity C1 (222-1) and activity C2 (222-2).

As mentioned above, the determining system (204) includes the opportunity determining engine (216-2). The opportunity determining engine (216-2) determines the opportunities (212) associated with the number of applications (206). For example, opportunity A (212-1) may be associated with application A (206-1). For example, any activity (208) performed, by a user, on application A (206-1) may directly contribute to outcome A (218-1). As a result, the opportunity determining engine (216-2) determines the opportunity A (212-1) is associated with application A (206-1). Similarly, opportunity B (212-2) may be associated with application B (206-2) and opportunity C (212-3) may be associated with application C (206-3).

The determining system (204) further includes the identifying engine (216-3). In one example, the identifying engine (216-3) identifies content related to the opportunities (212). In one example, the content may be items associated with a customer and/or an industry. For example, the content may be used to determine if an individual or a team sold a product to a customer. In this example, the content may be used as an index to determine what factors are relevant to the outcomes (218).

As mentioned above, the determining system (204) further includes the outcome determining engine (216-4). In one example, the outcome determining engine (216-4) determines, based on monitoring the activities (208, 210, 222) of the user utilizing the number of applications (206), outcomes (218) for the activities of the user, the outcomes (218) being associated with the opportunities (212) stored in the CRM system (208). For example, the outcome determining engine (216-4) determines, based on monitoring the activities (208, 210, 22) of the user utilizing application A (206-1), outcome A (218-1) is a successful outcome. Similarly, the outcome determining engine (216-4) determines, based on monitoring the activities (210) of the user utilizing application B (206-2), outcome B (218-2) is an unsuccessful outcome. Further, the outcome determining engine (216-4) determines, based on monitoring the activities (212) of the user utilizing application C (206-3), outcome C (218-3) is a successful outcome.

The determining system (204) further includes the assigning engine (216-5). The assigning engine (216-5) assigns a contribution value to the outcomes (218) based on the activities (208, 210, 222) of the user. In one example, the contribution value may be an amount of time a user contributes to an outcome of an opportunity. For example, if a user contributes three hours of their time to outcome A (218-1) of opportunity A (218-1), a contribution value of three may be assigned to outcome A (218-1) of opportunity A (218-1). In one example, the amount of time may be measured in minutes, hours, days, weeks, months, years, other measurements of time, or combinations thereof. Further, the contribution value may be further based on a position of the user, a responsibility of the user, a customer contact of the user, an activity type for the activities, a contract, a commission for the user, or combinations thereof.

As mentioned above, the determining system (204) includes the monetary value determining engine (216-6). In one example, the monetary value determining engine (216-6) determines, based on the contribution value, a monetary value for the outcomes (218). In one example, the monetary value may be a cost, in terms of currency, for an outcome of an opportunity to be realized. In one example, the monetary value may be calculated by multiplying a compensation value by a compensation rate of a user who contributed to an outcome of an opportunity. In another example, the monetary value may be calculated by multiplying a compensation value by a compensation rate of an organization who contributed to an outcome of an opportunity. For example, if the user contributed three hours of their time to outcome A (218-1) of opportunity A (218-1) and the hourly rate of the user is twenty dollars per hour, the monetary value is sixty dollars for outcome A (218-1). As a result, a company may use this information for billing purposes.

In one example, the monetary value is further derived, from an employee human factor (HR) system (220). In one example, the HR system (220) includes information associated with the user. For example, the information associated with the user includes a title of the user within a company, a rank of the user within the company, a position of the user within the company, or combinations thereof. If the user is member A (218-1), the monetary value is derived, from the HR system (220) based on member A's information. If the user is member B (218-2), the monetary value is derived, from the HR system (220) based on member B's information. Further, the system may interface with a cost management system to further derive the correct monetary value in which to apportion time. As a result, the system (200) allows the monetary value assigned to the outcome to accurately reflects the user's contribution to the outcome in terms of currency. As mentioned above, the monetary value may be further used for billing purposes by a company.

While this example has been described with reference to determining a monetary value for an outcome based on a user's activity, the system may determine a monetary value for an outcome based on a number of user's activity. Further, the system may determine a monetary value for an outcome based on an organization's activity.

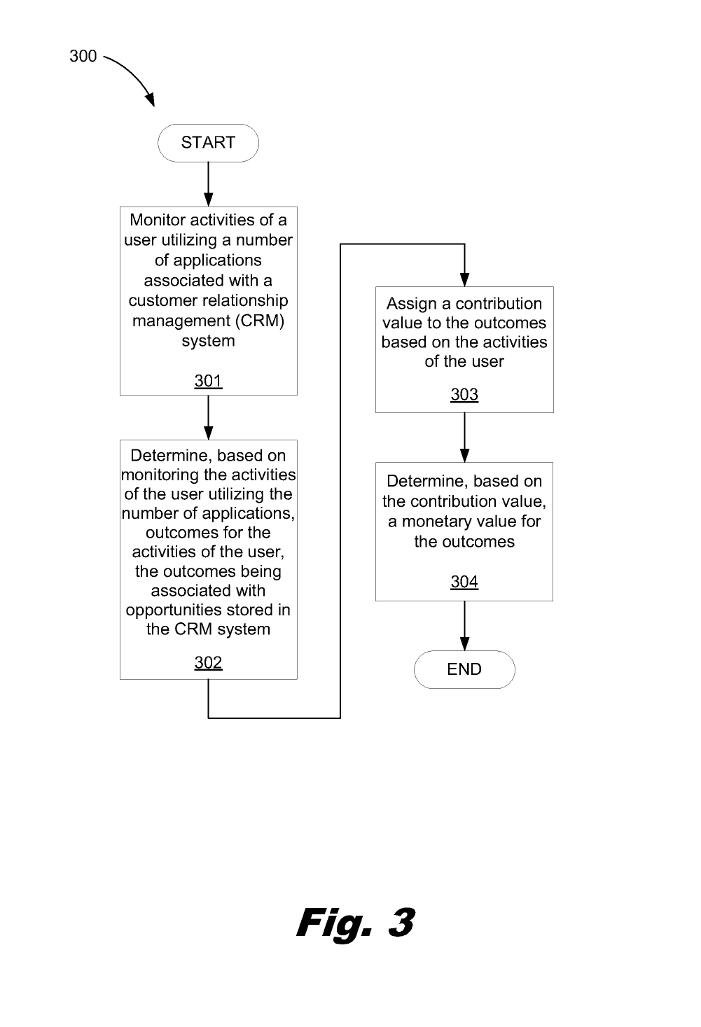

FIG. 3 is a flowchart of an example of a method for determining a monetary value for an outcome based on a user's activity, according to one example of principles described herein. In one example, the method (300) may be executed by the integrating system (100) of FIG. 1. In other examples, the method (300) may be executed by other systems (i.e. system 500 and system 600). In this example, the method (300) includes monitoring (301) activities of a user utilizing a number of applications associated with a CRM system, determining (302), based on monitoring the activity of the user utilizing the number of applications, outcomes for the activities of the user, the outcomes being associated with opportunities stored in the CRM system, assigning (303) a contribution value to the outcomes based on the activities of the user, and determining (304), based on the contribution value, a monetary value for the outcomes.

As mentioned above, the method (300) includes monitoring (301) activities of a user utilizing a number of applications associated with a CRM system. In one example, a monitoring engine monitors activities of a user utilizing a number of applications associated with the CRM system. In one example, the number of applications may be email applications, instant message applications, web conference applications, phone call applications, meeting applications, social media applications, or combinations thereof.

As mentioned above, the method (300) includes determining (302), based on monitoring the activity of the user utilizing the number of applications, outcomes for the activities of the user, the outcomes being associated with opportunities stored in the CRM system. In one example, an outcome determining engine determines, based on monitoring the activities of the user utilizing the number of applications, outcomes for the activities of the user, the outcomes being associated with the opportunities stored in the CRM system. For example, the outcome determining engine determines, based on monitoring the activities of the user utilizing application A, outcome A is a successful outcome.

As mentioned above, the method (300) includes assigning (303) a contribution value to the outcomes based on the activities of the user. In one example, the contribution value may be an amount of time a user contributes to an outcome of an opportunity. For example, if a user contributes three hours of their time to outcome A of opportunity A, a contribution value of three may be assigned to outcome A of opportunity A. In one example, the amount of time may be measured in minutes, hours, days, weeks, months, years, other measurements of time, or combinations thereof.

Further, the contribution value may be further based on a position of the user, a responsibility of the user, a customer contact of the user, an activity type for the activities, a contract, a commission for the user, or combinations thereof. For example, a position of a user may indicate if the user is significant or insignificant to the outcome. As a result, this information may further determine the user's contribution value. Further, if the user is a manager, the responsibility of the user may be significant and may further determine the user's contribution value. If a customer contact if significant for the user, this information may further determine the user's contribution value. In some examples, an activity type may allow a user to contribute more or less to an outcome. As a result, the activity type may further determine the user's contribution value. In other example, the commission for the user may determine the contribution value. For example, if user A received a commission of twenty dollars for outcome A and user B received a commission of forty dollars for outcome A, user B may have contributed twice as much to outcome A as user A did.

As mentioned above, the method (300) includes determining (304), based on the contribution value, a monetary value for the outcomes. In one example, a monetary value determining engine determines, based on the contribution value, a monetary value for the outcomes. As mentioned above, the monetary value may be a cost, in terms of currency, for an outcome of an opportunity to be realized. In one example, the monetary value may be calculated by multiplying a compensation value by a compensation rate of a user who contributed to an outcome of an opportunity. In another example, the monetary value may be calculated by multiplying a compensation value by a compensation rate of an organization who contributed to an outcome of an opportunity. For example, if the user contributed three hours of their time to outcome A of opportunity A and the hourly rate of the user is twenty dollars per hour, the monetary value is sixty dollars for outcome A. As a result, a company may use this information for billing purposes.

In one example, the monetary value is further derived, from an HR system. As mentioned above, the HR system includes information associated with the user. For example, the information associated with the user includes a title of the user within a company, a rank of the user within the company, a position of the user within the company, or combinations thereof. Often, a title, rank, or position of a user within a company influences a user's compensation rate. For example, if a user A's title is chief executive officer (CEO), user A may have a compensation rate of one-hundred dollars per hour. As a result, this information may be derived from the HR system for user A. Further, the system may interface with a cost management system to derive the correct monetary value in which to apportion time. As a result, the method (300) allows the monetary value assigned to the outcome to accurately reflects the user's contribution to the outcome in terms of currency. Further, the monetary value may be further used for billing purposes by a company.

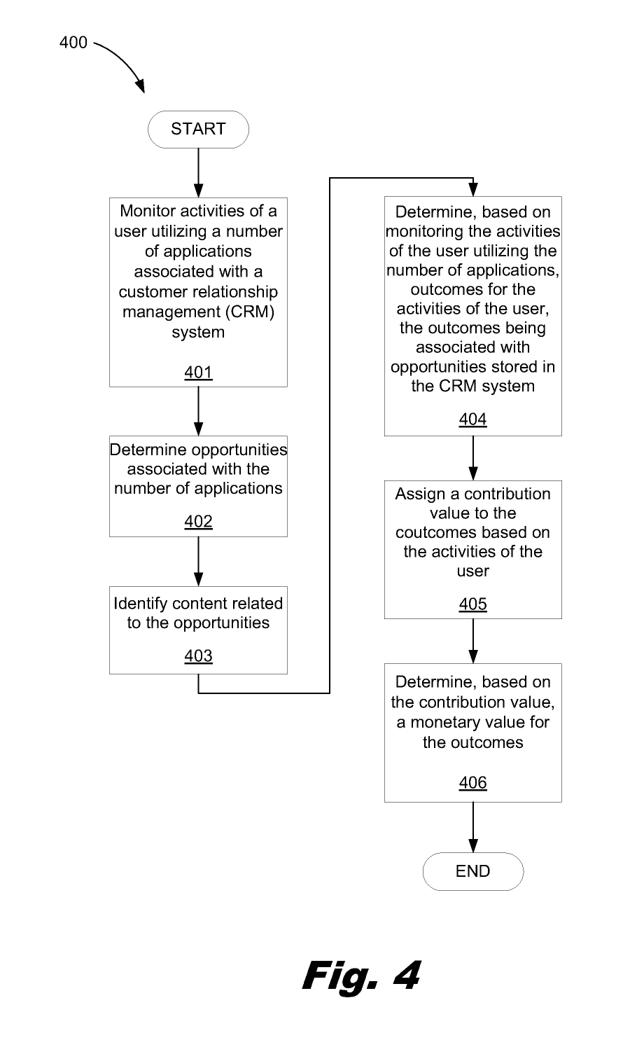

FIG. 4 is a flowchart of an example of a method for determining a monetary value for an outcome based on a user's activity, according to one example of principles described herein. In one example, the method (400) may be executed by the determining system (100) of FIG. 1. In other examples, the method (400) may be executed by other systems (i.e. system 200, system 500, and system 600). In this example, the method (400) includes monitoring (401) activities of a user utilizing a number of applications associated with a CRM system, determining (402) opportunities associated with the number of applications, identifying (403), content related to the opportunities, determining (404), based on monitoring the activity of the user utilizing the number of applications, outcomes for the activities of the user, the outcomes being associated with opportunities stored in the CRM system, assigning (405) a contribution value to the outcomes based on the activities of the user, and determining (406), based on the contribution value, a monetary value for the outcomes.

As mentioned above, the method (400) includes determining (402) opportunities associated with the number of applications. In one example, an opportunity determining engine determines the opportunities associated with the number of applications. For example, opportunity A may be associated with application A based on the activity for application A. As a result, the opportunity determining engine determines the opportunity A is associated with application A.

As mentioned above, the method (400) includes identifying (403), content related to the opportunities. In one example, an identifying engine identifies content related to the opportunities. In one example, the content may be items associated with a customer and/or an industry. For example, the content may be used to determine if an individual or a team sold a product to a customer. In this example, the content may be used as an index to determine what factors are relevant to the outcomes.

FIG. 5 is a diagram of an example of a determining system, according to the principles described herein. The determining system (500) includes a monitoring engine (502), an outcome determining engine (504), an assigning engine (506), and a monetary determining engine (508). In this example, the determining system (500) also includes an opportunity determining engine (510) and an identifying engine (512). The engines (502, 504, 506, 508, 510, 512) refer to a combination of hardware and program instructions to perform a designated function. Each of the engines (502, 504, 506, 508, 510, 512) may include a processor and memory. The program instructions are stored in the memory and cause the processor to execute the designated function of the engine.

The monitoring engine (502) monitors activities of a user utilizing a number of applications associated with a CRM system. In one example, the monitoring engine (502) monitors activities of a user a number of applications associated with a CRM system such as email applications, instant message applications, web conference applications, phone call applications, meeting applications, social media applications, or combinations thereof.

The outcome determining engine (504) determines, based on monitoring the activities of the user utilizing the number of applications, outcomes for the activities of the user, the outcomes being associated with the opportunities stored in the CRM system. As mentioned above, the outcomes may be successful or unsuccessful for the opportunities stored in the CRM system. In one example, the outcome determining engine (504) determines, based on monitoring the activities of the user utilizing the number of applications, successful outcomes for the activities of the user. In another example, the outcome determining engine (504) determines, based on monitoring the activities of the user utilizing the number of applications, unsuccessful outcomes for the activities of the user.

The assigning engine (506) assigns a contribution value to the outcomes based on the activities of the user. In one example, the contribution value is further based on a position of the user, a responsibility of the user, a customer contact of the user, an activity type for the activities, a contract, a commission for the user, or combinations thereof.

The monetary value determining engine (508) determines, based on the contribution value, a monetary value for the outcomes. In one example, the monetary value determining engine (508) derives, from an HR system, information associated with a user. In one example, the information includes a title of the user within a company, a rank of the user within the company, a position of the user within the company, or combinations thereof.

The opportunity determining engine (510) determines opportunities associated with the number of applications. In one example, the opportunity determining engine (510) determines an opportunity associated with an application. In another example, the opportunity determining engine (510) determines an opportunity associated with several applications.

The identifying engine (512) identifies content related to the opportunities. In one example, the content may be items associated with a customer and/or an industry. For example, the content may be used to determine if an individual or a team sold a product to a customer. In this example, the content may be used as an index to determine what factors are relevant to the outcomes.

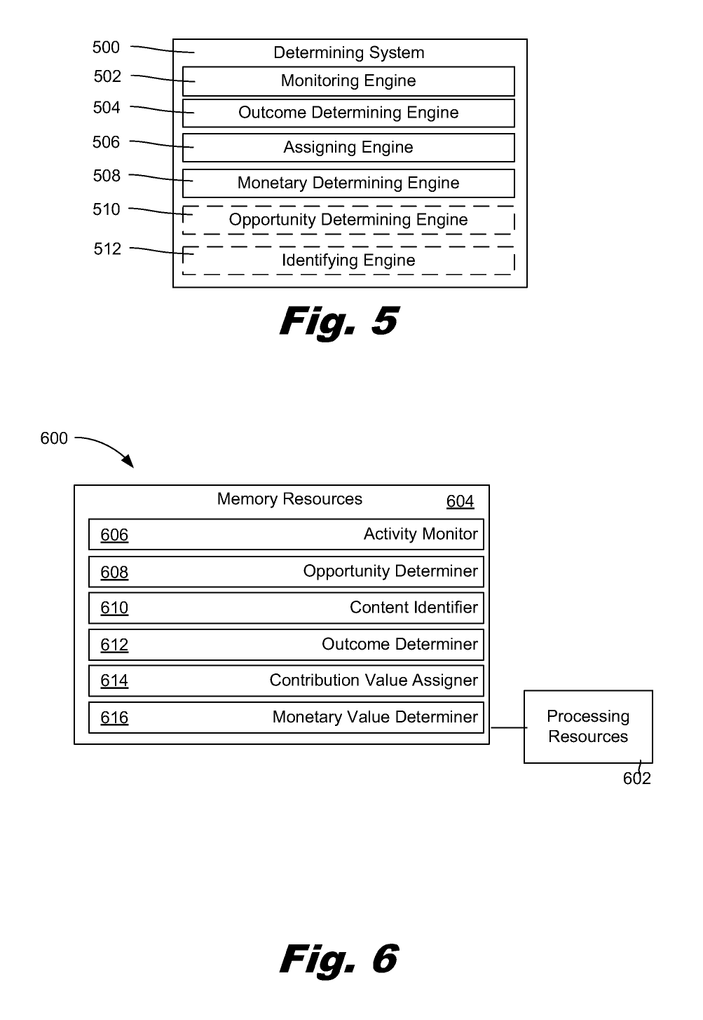

FIG. 6 is a diagram of an example of a determining system, according to the principles described herein. In this example, the determining system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the determining system (600). The programmed instructions shown stored in the memory resources (604) include an activity monitor (606), an opportunity determiner (608), a content identifier (610), an outcome determiner (612), a contribution value assigner (614), and a monetary value determiner (616).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The activity monitor (606) represents programmed instructions that, when executed, cause the processing resources (602) to monitor activities of a user utilizing a number of applications associated with a CRM system. The opportunity determiner (608) represents programmed instructions that, when executed, cause the processing resources (602) to determine opportunities associated with the number of applications.

The content identifier (610) represents programmed instructions that, when executed, cause the processing resources (602) to identify content related to the opportunities. The outcome determiner (612) represents programmed instructions that, when executed, cause the processing resources (602) to determine, based on monitoring the activities of the user utilizing the number of applications, outcomes for the activities of the user, the outcomes being associated with the opportunities stored in the CRM system.

The contribution value assigner (614) represents programmed instructions that, when executed, cause the processing resources (602) to assign a contribution value to the outcomes based on the activities of the user. The monetary value determiner (616) represents programmed instructions that, when executed, cause the processing resources (602) to determine, based on the contribution value, a monetary value for the outcomes.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, determining system (600) may be implemented on a user device, on a server, on a collection of servers, or combinations thereof.

The determining system (600) of FIG. 6 may be part of a general purpose computer. However, in alternative examples, the determining system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A method for determining a monetary value for an outcome based on a user's activity, the method comprising:
monitoring activities of a user utilizing a number of applications associated with a customer relationship management (CRM) system;
determining, based on monitoring the activities of the user utilizing the number of applications, outcomes for the activities of the user, the outcomes being associated with opportunities stored in the CRM system;
assigning a contribution value to the outcomes based on the activities of the user; and
determining, based on the contribution value, a monetary value for the outcomes.

2. The method of claim 1, in which the number of applications comprise electronic mail (email) applications, instant message applications, web conference applications, phone call applications, meeting applications, social media applications, or combinations thereof.

3. The method of claim 1, further comprising determining the opportunities associated with the number of applications.

4. The method of claim 1, further comprising identifying content related to the opportunities.

5. The method of claim 1, in which the contribution value is further based on a position of the user, a responsibility of the user, a customer contact of the user, an activity type for the activities, a contract, a commission for the user, or combinations thereof.

6. The method of claim 1, in which determining the monetary value to the outcomes based on the activities of the user further comprises deriving, from an employee human factor (HR) system, information associated with the user.

7. The method of claim 6, in which the information associated with the user comprises a title of the user within a company, a rank of the user within the company, a position of the user within the company, or combinations thereof.
